(19) United States
(12) Patent Application Publication
(10) Pub. No.: US 2013/0106280 A1
(43) Pub. Date: May 2, 2013

(54) CERAMIC METAL HALIDE LAMP

(71) Applicant: Iwasaki Electric Co., Ltd., Tokyo (JP)

(72) Inventor: Yasushi Sasai, Gyoda City (JP)

(73) Assignee: IWASAKI ELECTRIC CO., LTD., Tokyo (JP)

(21) Appl. No.: 13/661,795

(22) Filed: Oct. 26, 2012

(30) Foreign Application Priority Data
Oct. 31, 2011 (JP) 2011-239087

(51) Int. Cl. H01J 61/36; H01J 9/26

(52) U.S. Cl. 313/567; 445/44

(57) ABSTRACT

A manufacturing method of a ceramic metal halide lamp is provided where electrical characteristics and optical characteristics changed at the first time when the lamp begins to glow can be decreased. An example lamp includes a luminous tube with silver iodide (AgI) enclosed therein with predetermined amounts of mercury, metal halides and rare gas. Luminous flux change is measured by changing AgI/total amount of metal halide (weight ratio). An upper limit of AgI is determined by specifying an upper limit value of AgI/total amount of metal halide (weight ratio) based on an allowable lowering rate of luminous flux. Lamp voltage change is measured by changing AgI/total amount of metal halide. A lower limit of AgI is determined by specifying the AgI/total amount of metal halide based on an allowable lowering rate of lamp voltage. An AgI amount falling between the upper and lower limits is sealed into the luminous tube.

### BACKGROUND OF THE INVENTION

1. Field of the Invention

The present invention relates to a ceramic metal halide lamp.

2. Description of Related Art

A high-pressure mercury lamp, a high-pressure sodium lamp, a metal halide lamp and a ceramic metal halide lamp, for example, are known as a high-intensity discharge lamp (HID lamp). The HID lamp is adapted to produce light by effectively utilizing discharge between electrodes provided therein. Therefore, as compared with an incandescent lamp, the high-intensity discharge lamp has distinguishing characteristics such as large luminous flux, being suitable for use in illumination of a large-scale space and having high energy efficiency.

In the HID lamps, a metal halide lamp that uses metal halides as a luminous material has merits such as excellent color rendering property to produce light close to white light (natural light) as compared with a mercury lamp to produce rays of bluish-white light. Moreover, this metal halide lamp has a merit of high luminous efficiency.

It has been customary to use a quartz luminous tube as a luminous tube for use with a metal halide lamp. In recent years, a translucent ceramic luminous tube is used instead of the quartz luminous tube. A metal halide lamp using a ceramic luminous tube is called, especially, a “ceramic metal halide lamp”.
[Patent Literature 1] Japanese Unexamined Patent Application Publication (Translation of PCT application) No. 2000-516901 “STRENGTHENED METAL HALIDE PARTICLES AND IMPROVED LAMP FILL MATERIAL AND METHOD THEREFOR” (Date of publication: Dec. 19, 2000).
[Patent Literature 2] Japanese Unexamined Patent Application Publication No. 2008-10272 “Ceramic metal halide lamp” (Date of laid-open: Jan. 17, 2008).

### BRIEF SUMMARY OF THE INVENTION

A ceramic metal halide lamp has a tendency to change its electrical characteristics in the early stage in which the lamp begins to glow after it was completed as a product and this metal halide lamp also tends to change its optical characteristics in accordance with the change of the electrical characteristics. In particular, electrical characteristics and optical characteristics of the ceramic metal halide lamp are changed with violence during 10 hours passed after the ceramic metal halide lamp had begun to glow. After 100 hours, electrical characteristics and optical characteristics of the ceramic metal halide lamp become stable. The change of the electrical characteristics may emerge as a lowering of a lamp voltage and the change of the optical characteristics may emerge as a change of color.

If a ceramic metal halide lamp is designed under the specifications to raise an initial lamp voltage in order to compensate a lowering of a lamp voltage, there then arise problems known as the extinguishment of lamp and the like.

Accordingly, it is an object of the present invention to provide a ceramic metal halide lamp which can decrease electrical characteristics and optical characteristics changed at the first time when a lamp begins to glow.

Further, it is an object of the present invention to provide a manufacturing method of a ceramic metal halide lamp which can decrease electrical characteristics and optical characteristics changed at the first time when a lamp begins to glow.

In one or more embodimets of the present invention, a manufacturing method of a ceramic metal halide lamp, silver iodide (AgI) being sealed into a luminous tube of said ceramic metal halide lamp together with a predetermined quantity of mercury, metal halides and an inert gas, comprising the steps of: measuring a change of luminous flux by changing AgI/total amount of metal halide (weight ratio) and determining an upper limit amount of silver iodide (AgI) by specifying an upper limit value of said AgI/total amount of metal halide based on an allowable lowering rate of luminous flux; measuring a change of a lamp voltage by changing said AgI/total amount of metal halide and determining a lower limit amount of said silver iodide (AgI) by specifying a lower limit value of said AgI/total amount of metal halide based on an allowable lowering rate of a lamp voltage; sealing silver iodide (AgI) of an amount which falls within an upper limit amount and a lower limit amount of said silver iodide (AgI) into a luminous tube together with other sealed materials to thereby complete a luminous tube; and manufacturing a lamp by using said luminous tube.

Further, in one or more embodimets of the present invention, a ceramic metal halide lamp manufactured by the above manufacturing method.

Further, in one or more embodimets of the present invention, a manufacturing method of a ceramic metal halide lamp, silver iodide (AgI) being sealed into a luminous tube of said ceramic metal halide lamp together with a predetermined quantity of mercury, metal halides and an inert gas, comprising the steps of: measuring a change of a lamp voltage by changing AgI/total amount of metal halide (weight ratio) and determining a lower limit amount of silver iodide (AgI) by specifying a lower limit value of said AgI/total amount of metal halide based on an allowable lowering rate of a lamp voltage; measuring a change of luminous flux by changing said AgI/total amount of metal halide (weight ratio) and determining an upper limit amount of said silver iodide AgI by specifying an upper limit value of said AgI/total amount of metal halide based on an allowable lowering rate of luminous flux; sealing silver iodide (AgI) of an amount which falls within an upper limit amount and a lower limit amount of said silver iodide (AgI) into a luminous tube together with other sealed materials to thereby complete a luminous tube; and manufacturing a lamp by using said luminous tube.

Further, in one or more embodimets of the present invention, a ceramic metal halide lamp manufactured by the above manufacturing method.

Further, in one or more embodimets of the present invention, a ceramic metal halide lamp using a luminous tube into which there are sealed silver iodide specified by the following equations.

0.1≦AgI/total amount of metal halide (weight ratio)≦0.35

Further, in the above ceramic metal halide lamp, said ceramic metal halide lamp may use a luminous tube in which a gap (total gap of upper and lower gaps) between an electrode mount and a thin tube portion falls within a range of 0.1±0.05 mm.

Further, in one or more embodimets of the present invention, a ceramic metal halide lamp using a luminous tube into which there are sealed silver bromide specified by the following equations.

0.1≦AgBr/total amount of metal halide (weight ratio)≦0.35

Further, in the above ceramic metal halide lamp, wherein said ceramic metal halide lamp may use a luminous tube in which a gap (total gap of upper and lower gaps) between an electrode mount and a thin tube portion falls within a range of 0.1±0.05 mm.

According to the above embodimets of the present invention, it is possible to provide a ceramic metal halide lamp which can decrease electrical characteristics and optical characteristics changed at the first time when a lamp begins to glow.

Furthermore, according to the above embodimets of the present invention, it is possible to provide a manufacturing method of a ceramic metal halide lamp which can decrease electrical characteristics and optical characteristics changed at the first time when a lamp begins to glow.

### BRIEF DESCRIPTION OF THE DRAWINGS

FIG. 1A is a front view of a ceramic metal halide lamp to explain a structure therof.

FIG. 1B is a side view of the ceramic metal halide lamp.

FIG. 2A is a diagram used to explain the whole of a luminous tube to explain details of the luminous tube,

FIG. 2B is a diagram showing a thin tube portion 4c encircled by □ (open rectangle) shown in FIG. 2A in an enlarged-scale.

FIG. 3A is a graph of data obtained from a ceramic metal halide lamp with a rated output of 100 W and shows a lamp voltage changed at the first time period when the lamp begins to glow (0 to 100 hours).

FIG. 3B is a graph obtained by rewriting FIG. 3A.

FIG. 4 is a graph of data indicative of a percent change of luminous flux obtained by varying AgI/total amount in a range of zero to 0.5 after a lamp began to glow at the first time (i.e. after 100 hours).

FIG. 5 is a graph of data indicative of a percent change of a lamp voltage obtained by varying AgI/total amount in a range of zero to 0.5 after a lamp began to glow at the first time (i.e. 100 hours).

FIG. 6 is a flowchart of a manufacturing method of a lamp and shows, in particular, processes to determine a scope of a generalized AgI/total amount.

### DETAILED DESCRIPTION OF THE INVENTION

A ceramic metal halide lamp according to one or more embodiments of the present invention will be described below with reference to the accompaning drawings. It should be noted that, in the drawings, identical elements are denoted by the identical reference numerals and overlapping description will be omitted.

### [Ceramic Metal Halide Lamp]

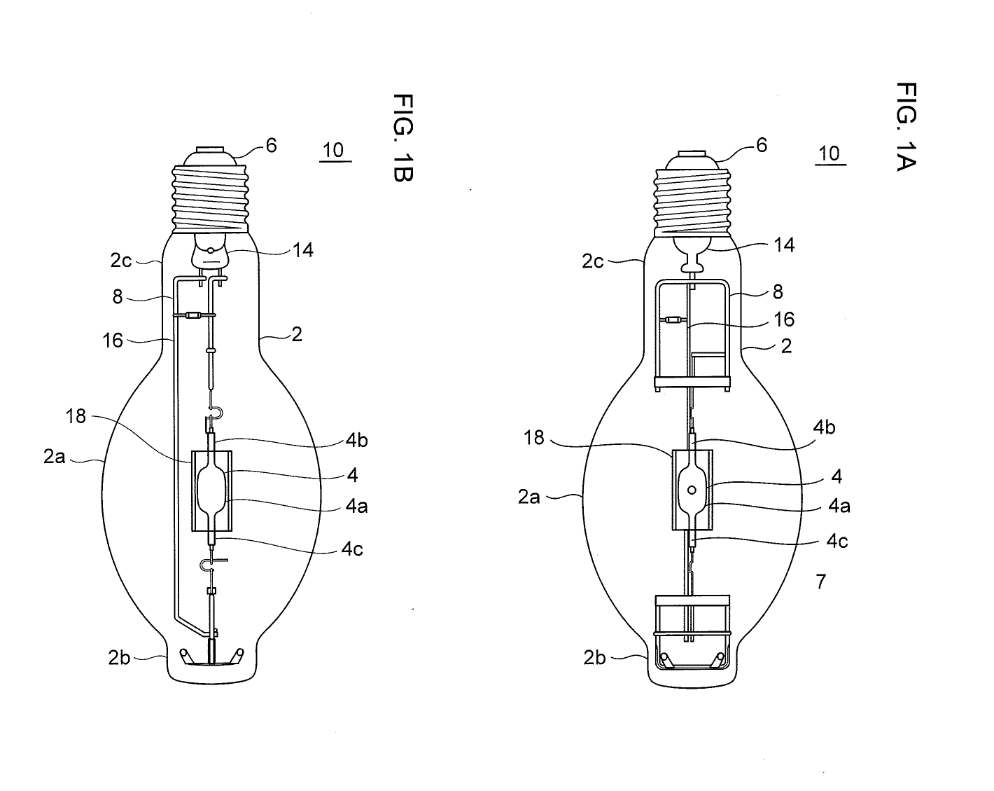

FIGS. 1A and 1B is a diagram used to explain a structure of a ceramic metal halide lamp, wherein FIG. 1A is a front view of a lamp and FIG. 1B is a side view thereof. A lamp 10 includes an outer bulb 2 enclosing therein a luminous tube (arc tube) 4 that serves as a light-emitting portion and an inner tube 18 surrounds the periphery of the luminous tube. An E-type base 6 is joined to the end portion of the outer bulb 2. The luminous tube 4 is supported to a predetermined position by a mount 8 that comprises a structure formed of a combination of metal wire material and plates to which the inner tube 18 is attached, thereby the luminous tube being supplied of electricity.

Those elements will be explained in brief, respectively.

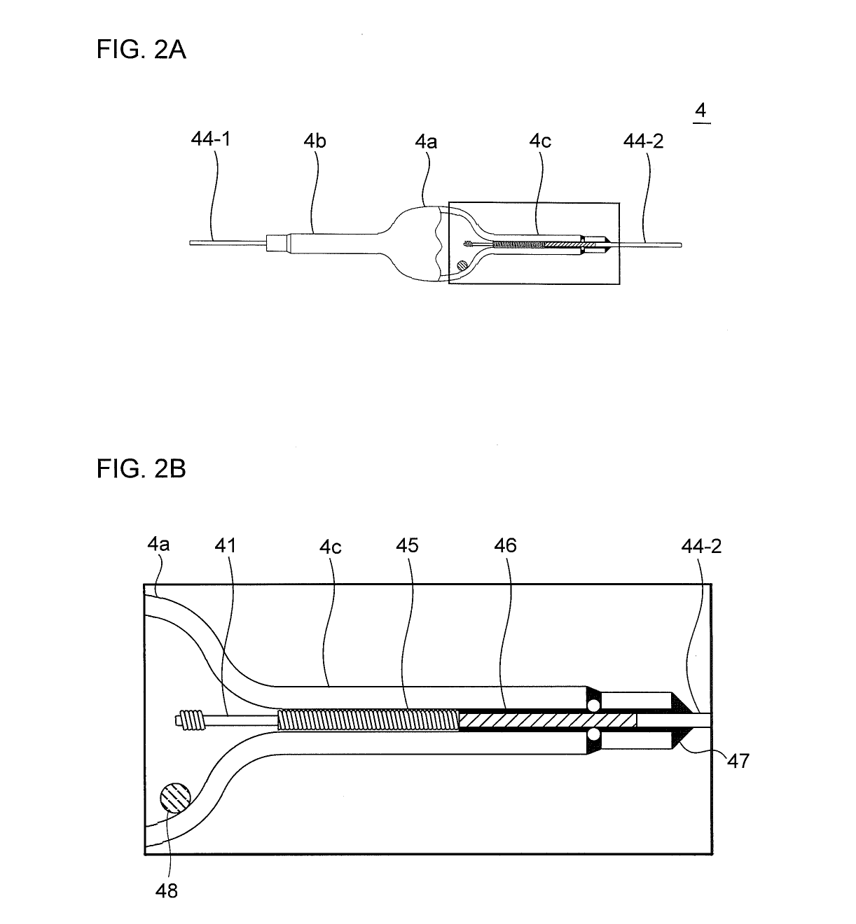

The luminous tube 4 will be explained later on in relation to FIG. 2.

The mount 8 comprises mainly a stem tube 14 with a pair of lead-in wires hermetically sealed therein and a support 16 formed of a wire material such as a nickel-plated iron wire and a round-bar material molded as a nearly rectangular-shaped frame.

The inner tube 18 is disposed to surround the periphery of the luminous tube 4 in order to protect the outer bulb from influences exerted on the luminous tube when the luminous tube 4 is exploded and is formed of a transparent quartz glass tube. The inner tube 18 may be formed of either an open-type inner tube or a closed-type inner tube.

The outer bulb 2 is made of a translucent hard glass such as a borosilicate glass, for example. The outer bulb may be formed of either a transparent-type outer bulb or diffusing-type (opaque) outer bulb. The outer bulb 2 is of a BT-type outer bulb including a central portion 2a with a maximum diameter, a closed top portion 2c in the left side as seen from the sheet of drawing and a neck portion 2b in the right side as seen from the sheet of drawing. The neck portion 2b includes a sealed portion into which a flare portion of the stem tube 14 is sealed. After the flare portion of the stem tube was sealed into the sealed portion, the outer bulb 2 is evacuated through an exhaust pipe (not shown) disposed at the neck portion, whereafter an inert gas such as an argon (Ar) gas and a nitrogen (N₂) gas is sealed into the outer bulb or the outer bulb is evacuated in the airtight atmosphere.

The screw-in base 6 is joined to the outer bulb so as to cover this sealed portion by using a heat-resistant adhesive or the base 6 is screwed to a molded thread groove and thereby attached to the outer bulb.

The lamp 10 shown in FIG. 1 is connected to a power supply through the base 6 attached to a socket (not shown) and is energized by the power supply through a predetermined lighting circuit apparatus so that the lamp can keep glowing stably through discharge between main electrodes.

### [Process Required Until an Embodiment of the Invention is Completed]

A ceramic metal halide lamp has a tendency to lower a lamp voltage at the first time when it beings to glow after it was completed as a product and tends to change color in accordance with the lowering of the lamp voltage.

Having investigated and analyzed a luminous tube of which lamp voltage was lowered, the inventor of the present application found one of such causes to lower a lamp voltage such that a material sealed into the thick tube portion 4a of the luminous tube 4 penetrates a gap between the electrode mount and the thin tube portion with the result that a sealed material within the thick tube portion 4a is decreased.

FIGS. 2A and 2B is a diagram used to explain the details of the luminous tube, wherein FIG. 2A is a diagram used to explain the whole of the luminous tube and FIG. 2B is a diagram showing a thin tube portion 4c encircled by □ (open rectangle) shown in FIG. 2A in an enlarged-scale. As shown in FIG. 2A, the luminous tube 4 is a translucent ceramic vessel of a shape formed of the central thick tube portion 4a and thin tube portions (referred to also as “capillaries”) 4b, 4c formed at both ends of the thick tube portion. A pair of lead wires 44-1, 44-2 is respectively extended through these thin tube portions 4b, 4c to the area of the thick tube portion 4a, thereby a pair of tungsten (W) main electrodes being formed. Mercury of a predetermined quantity and metal halides and an argon (Ar) gas with a predetermined pressure serving as a rare gas or the like are sealed into the vessel of the thick tube portion 4a as light-emitting and discharging mediums to improve characteristics such as luminous efficiency, color rendering property and color temperature.

A phenomenon in which the material sealed into the thick tube portion 4a penetrates the gap between the electrode mount and the thin tube portion will be explained with reference to FIG. 2B. The thin tube portion 4c connected to the thick tube portion 4a is made of a polycrystalline alumina (PCA). A lead wire 44-2 is inserted from the tip end portion of the thin tube portion 4c into the thin tube portion along the axis, connected to a cermet 46 and further connected to a molybdenum coil rod 45, whereafter a tungsten electrode rod 41 is formed at the top of the molybdenum coil rod. A tip end portion of the thin tube portion 4c is sealed by frit (sealing material). The thin tube portion 4b has a structure similar to that of the thin tube portion 4c.

A metal halide of a sealed material 48 is sealed into the thick tube portion 4a in the solid state (powder, pellet, etc.) when the luminous tube is manufactured. This metal halide is placed in a mixed state of a liquid and a gas during the ceramic metal halide lamp is glowing. A very small quantity of metal halide permeates into the tip end of the thin tube portion through the gap between the thin tube portion 4c and the molybdenum coil rod 45 and erodes the polycrystalline alumina. As a result, the quantity of the sealed material within the thick tube portion 4a of the luminous tube decreases to cause a lamp voltage to be lowered and color of light to be changed. By adding an upper gap and a lower gap, it is to be noted that the size of the gap between the thin tube portion 4c and the molybdenum coil rod 45 should fall within a range of 0.1±0.05 mm. Such ceramic luminous tube was developed by ROYAL PHILIPS ELECTRONICS and the fundamental structure thereof was not varied later on.

Therefore, in the beginning, the inventor of the present application has taken the following two steps as countermeasures to cope with the phenomenon in which the sealed material permeates into the gap between the electrode mount and the thin tube portion.

Countermeasure 1: By increasing a quantity of a sealed material sealed into the thick tube portion 4a, it is possible to maintain a necessary quantity of a sealed material in the thick portion 4a even when the sealed material permeates into the gap to decrease the quantity of the sealed material.

Countermeasure 2: The gap between the electrode mount of the thin tube portion and the thin tube portion should be narrowed as much as possible. However, under the present circumstances, when the gap between the electrode mount of the thin tube portion and the thin tube portion is narrowed more, size tolerance of the parts should be determined strictly in order to positively insert the electrode mount into the thin tube portion, which gives rise to a lowering of yield and hence a ceramic metal halide lamp becomes costly. Moreover, it became clear that the above-described work to insert the electrode mount into the thin tube portion becomes difficult so that working efficiency is caused to be lowered. Thus, the above countermeasures are not yet adopted.

[Increase of Material Sealed into Thick Tube Portion]

However, when the quantity of the metal halide serving as the sealed material 48 within the thick tube portion 2a was increased with the same ratio as that of the present state, there was caused a problem of increasing a tendency in which the metal halide erodes the polycrystalline alumina in the thin tube portion 4c. In particular, if the sealed material 48 contains rare earth metal halides such as Dy, Ho and Tm, then an extent in which the sealed material erodes the polycrystalline alumina is increased remarkably.

Accordingly, the quantity of the metal halide was not increased but silver iodide (AgI) was added to the sealed material. The reason that the silver iodide is used is that the silver iodide is fundamentally unable to present a high peak level in the visible light region so that it does not affect the optical characteristics of the lamp considerably. Furthermore, since the silver iodide hardly reacts with the polycrystalline alumina that forms the thin tube portion, there is then no risk that the silver iodide will erode the polycrystalline alumina.

However, experiments had revealed that an excessive increase of a quantity of silver iodide exerts a delicate influence upon a luminous flux value of the lamp. Accordingly, experiments were carried out to determine a quantity of silver iodide relative to metal halides.

As a first stage, an upper limit value of a quantity of silver iodide was determined in a range such that the silver iodide may not affect a luminous flux value considerably. Inasmuch as a change of a luminous flux value falls within a range of ±5%, light with such change of luminous flux value is not incongruous with human eyes and it does not bring about a trouble in an actual use.

If on the other hand the quantity of silver iodide is small relative to the quantity of metal halide, then the metal halide permeates into a gap so that a lamp voltage cannot be suppressed from being lowered. Accordingly, as a second stage, a lower limit value of a quantity of silver iodide was specified in a range such that a lamp voltage may not be lowered considerably. Inasmuch as a change of a lamp voltage value falls within a range of ±5%, there arises no problem in an actual use.

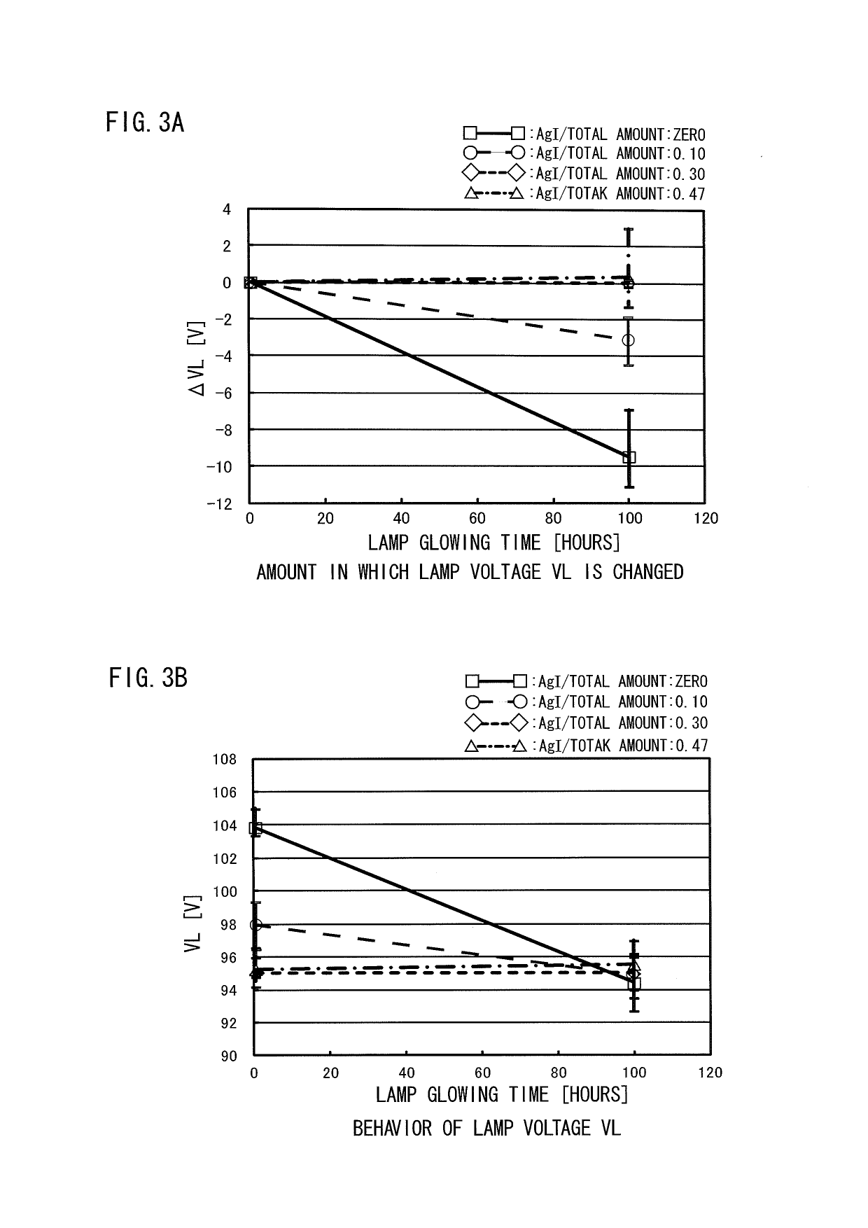

FIG. 3A is a graph indicative of data of a ceramic metal halide lamp with a rated output of 100 W and shows changes of a lamp voltage at the first time when a lamp begins to glow (0 to 100 hours). Weight ratios of the silver iodides to the total amount of metal halides (simply abbreviated as “AgI/total amount”, below) are taken as parameters, in which the AgI/total amount is set to 0.10, 0.30 and 0.47 and the AgI/total amount is set to zero as a comparative example. A study of FIG. 3A revealed that, when the AgI/total amount is set to zero, a lamp voltage VL is lowered from the initial value by −9V on the average. On the other hand, when the AgI/total amount is set to 0.10, 0.30 and 0.47, a lowering of the lamp voltage VL falls within a range wthin −3.1 V and a mean value reaches zero.

FIG. 3B is a graph obtained by rewriting FIG. 3A. When a ceramic metal halide lamp is installed in the vertical direction and energized to produce light, a predetermined voltage (e.g. rated voltage) is generally 130V and there exists a lamp of which voltage reaches 145V at maximum. If this lamp is installed in the horizontal direction and is energized by an inexpensive copper iron ballast to glow, then a lamp voltage increases more and reaches 160V. When the AgI/total amount is set to zero, it is expected that a lamp voltage is lowered in a range of from 7 to 11V, whereby a lamp voltage obtained at the beginning of shipping is set to 171V. In the case of this lamp, when a power supply voltage at the place in which the lamp is installed increases, a lamp voltage also increases in accordance with the increase of the power supply voltage. When a lamp voltage obtained during the lamp is glowing reaches 180V, there is a risk that a problem such as the extinguishment of a lamp will occur. When on the other hand the AgI/total amount is set to 0.10, 0.30 and 0.47, respectively, since it is not necessary to take a lowering of a lamp voltage into consideration substantially, a lamp voltage required at the first time when the lamp begins to glow horizontally after it was shipped can be set to 160V.

Based on the above-mentioned experiments, since it has been found that the addition of AgI is effective for decreasing the change of electrical characteristics and the change of optical characteristics, it is to be noted that a scope of the AgI/total amount should be determined next.

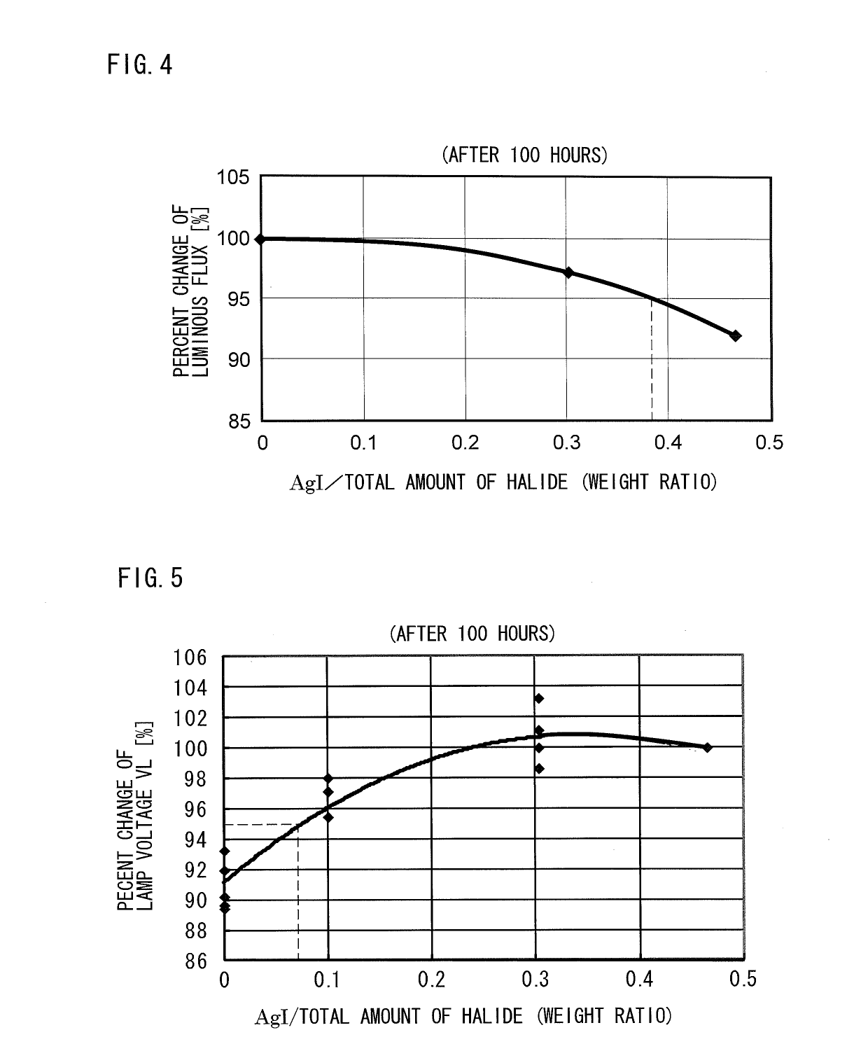

As a first stage, an upper limit value of the AgI/total amount is specified based on an allowable lowering rate of luminous flux. Thus, since the total amount of the material sealed into the lamp (i.e. total amount of metal halides) is clear, it is possible to determine the upper limit amount of AgI. FIG. 4 shows data indicative of a percent change of luminous flux obtained when the AgI/total amount was varied from zero to 0.5 since the lamp had begun to glow (i.e. after 100 hours). Luminous flux is lowered by increasing the AgI/total amount. If a lowering of luminous flux falls within 5%, then no trouble occurs in an actual use of the lamp. Accordingly, based on data shown in FIG. 4, the upper limit value of the AgI/total amount was specified as 0.35. Thus, it is possible to determine the upper limit value of the silver iodide (AgI).

As a second stage, a lower limit value of silver iodide is specified based on an allowable lowered value of a lamp voltage. Since the total amount of a material sealed into the lamp (i.e. total amount of metal halides) is clear, it is possible to determine the lower limit amount of the silver iodide (AgI). FIG. 5 shows data indicative of a percent change of a lamp voltage obtained when the AgI/total amount was varied from zero to 0.5 since the lamp had begun to glow (i.e. after 100 hours). Luminous flux is lowered by increasing the AgI/total amount. A lamp voltage is lowered by increasing the AgI/total amount. If a lowering of a lamp voltage falls within 5%, then no trouble occurs in an actual use of the lamp. Accordingly, based on data shown in FIG. 5, the upper limit value of the AgI/total amount is specified as 0.1. If the AgI/total amount=0.1 is satisfied, then even when a scope of dispersion of data is taken into consideration, a lowering rate of a lamp voltage becomes less than 5%. Thus, it is possible to determine the lower limit value of the silver iodide (AgI).

As set forth above, the scope of the AgI/total amount is specified so as to satisfy 0.1≦AgI/total amount≦0.35.

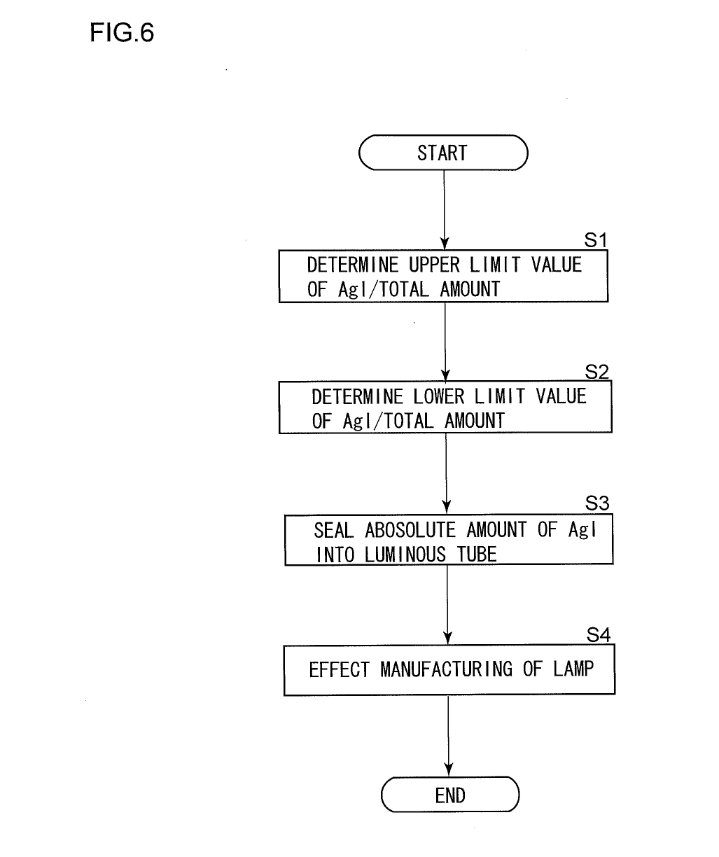

FIG. 6 is a flowchart of a lamp manufacturing process and shows processes to specify the scope of the AgI/total amount.

At a step 51, an upper limit value of AgI/total amount is determined. To be concrete, as shown in FIG. 4, a change of luminous flux is measured by varying the AgI/total amount. Then, an upper limit value of AgI/total amount is specified based on an allowable lowering rate of luminous flux and an upper limit amount of the silver iodide (AgI) is determined.

At a step S2, a lower limit value of AgI/total amount is determined. To be concrete, as shown in FIG. 5, a change of a lamp voltage is measured by varying the AgI/total amount. A lower limit value of AgI/total amount is specified based on an allowable lowering rate of a lamp voltage and a lower limit quantity of silver iodide (AgI) is determined It is to be noted that the steps S1 and S2 might be carried out in reverse order.

At a step S3, the AgI/total amount is specified within a range of the above-described lower limit value to the upper limit value. An absolute amount of silver iodide (AgI) that should be sealed into the luminous tube is decided and the silver iodide of the above absolute amount is sealed into the luminous tube together with other sealed materials thereby completing the luminous tube.

At a step S4, this luminous tube is used to manufacture a lamp.

### (Alternative)

The silver iodide (AgI) is used in the above-described embodiment. However, other silver halides, especially, a silver bromide (AgBr) have similar characteristics. Accordingly, it can be expected that the silver bromide (AgBr) can be used instead of the silver iodide (AgI).

Further, other metal iodides (copper iodide and gold iodide) also have characteristics substantially the same as those of the silver iodide and the silver bromide (AgBr). Accordingly, it can be expected that these other metal iodides are used instead of the silver iodide and the silver bromide.

### [Conclusion]

While the ceramic metal halide lamp with the outer bulb protective structure according to the embodiment of the present invention has been described so far, these descriptions are made by way of example and may not limit the scope of the present invention. Addition, cancellation, change, improvement and the like easily made on the embodiment by those skilled in the art may fall within the scope of the present invention. A technical scope of the present invention may be determined by the description of the attached claims.

1. A manufacturing method of a ceramic metal halide lamp, silver iodide (AgI) being sealed into a luminous tube of said ceramic metal halide lamp together with a predetermined quantity of mercury, metal halides and an inert gas, comprising the steps of:
measuring a change of luminous flux by changing AgI/total amount of metal halide (weight ratio) and determining an upper limit amount of silver iodide (AgI) by specifying an upper limit value of said AgI/total amount of metal halide based on an allowable lowering rate of luminous flux;
measuring a change of a lamp voltage by changing said AgI/total amount of metal halide and determining a lower limit amount of said silver iodide (AgI) by specifying a lower limit value of said AgI/total amount of metal halide based on an allowable lowering rate of a lamp voltage;
sealing silver iodide (AgI) of an amount which falls within an upper limit amount and a lower limit amount of said silver iodide (AgI) into a luminous tube together with other sealed materials to thereby complete a luminous tube; and
manufacturing a lamp by using said luminous tube.

2. A ceramic metal halide lamp manufactured by a manufacturing method according to claim 1.

3. A manufacturing method of a ceramic metal halide lamp, silver iodide (AgI) being sealed into a luminous tube of said ceramic metal halide lamp together with a predetermined quantity of mercury, metal halides and an inert gas, comprising the steps of:
measuring a change of a lamp voltage by changing AgI/total amount of metal halide (weight ratio) and determining a lower limit amount of silver iodide (AgI) by specifying a lower limit value of said AgI/total amount of metal halide based on an allowable lowering rate of a lamp voltage;
measuring a change of luminous flux by changing said AgI/total amount of metal halide (weight ratio) and determining an upper limit amount of said silver iodide (AgI) by specifying an upper limit value of said AgI/total amount of metal halide based on an allowable lowering rate of luminous flux;
sealing silver iodide (AgI) of an amount which falls within an upper limit amount and a lower limit amount of said silver iodide (AgI) into a luminous tube together with other sealed materials to thereby complete a luminous tube; and
manufacturing a lamp by using said luminous tube.

4. A ceramic metal halide lamp manufactured by a manufacturing method according to claim 3.

5. A ceramic metal halide lamp using a luminous tube into which there are sealed silver iodide specified by the following equations.
0.1≦AgI/total amount of metal halide (weight ratio)≦0.35

6. A ceramic metal halide lamp according to claim 5, wherein said ceramic metal halide lamp uses a luminous tube in which a gap (total gap of upper and lower gaps) between an electrode mount and a thin tube portion falls within a range of 0.1±0.05 mm

7. A ceramic metal halide lamp using a luminous tube into which there are sealed silver bromide specified by the following equations.
0.1≦AgBr/total amount of metal halide (weight ratio)≦0.35

8. A ceramic metal halide lamp according to claim 7, wherein said ceramic metal halide lamp uses a luminous tube in which a gap (total gap of upper and lower gaps) between an electrode mount and a thin tube portion falls within a range of 0.1±0.05 mm.
